(19) United States
(12) Patent Application Publication
(10) Pub. No.: US 2006/0238827 A1
(43) Pub. Date: Oct. 26, 2006

(54) Image processing apparatus, image processing system, and image processing program storage medium

(75) Inventors: Kyoko Ikeda, Kanagawa (JP); Shigeki Kawakami, Kanagawa (JP); Hirokazu Kameyama, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/407,280

(22) Filed: Apr. 20, 2006

(30) Foreign Application Priority Data
Apr. 20, 2005 (JP) 2005-122556

(51) Int. Cl. H04N 1/40

(52) U.S. Cl. 358/448

(57) ABSTRACT

An image processing apparatus comprises an image data obtaining section that obtains image data, an image analyzing section that analyzes an image represented by the image data obtained by the image data obtaining section, an image processing section that applies image processing to the image data obtained by the image data obtaining section in accordance with an analyzing result analyzed by the image analyzing section and a processing parameter for introducing processing contents from the analyzing result, and a parameter adjusting section that adjusts, prior to the image processing by the image processing section, the processing parameter in accordance with an operation.

### BACKGROUND OF THE INVENTION

1. Field of the Invention

The present invention relates to an image processing apparatus for applying image processing to image data, an image processing system, and an image processing program storage medium storing an image processing program, when executed in a computer, which causes the computer to operate as the image processing apparatus.

2. Description of the Related Art

Hitherto, in a field of printing, there is widely applied an image processing system in which a scanner is used to read an original image to obtain image data, so that an image processing apparatus applies a predetermined image processing to the image data, and a printer is used to output an image according to the image data. According to such an image processing system, an operator sets up an amount of correction for an image, such as density of highlight point and shadow point, and degree of color correction and tone conversion, so that the image processing is performed in accordance with the correction amount for the image thus set up. The suitable set up of the correction amount for the image makes it possible to correct the image represented by the image data to an image that is nice to look at.

By the way, while the work of setting up the correction amount for the image to a suitable value needs skilled technique, recently, there is well known an auto-set up in which characteristics, such as gradation of colors of an image represented by image data, are analyzed to automatically execute image processing (cf. for example, Japanese Patent Laid Open Gazette TokuKai 2000-182043, and Japanese Patent Laid Open Gazette TokuKai 2000-196890). According to the auto-set up, there are previously prepared processing parameters, such as density values for the target for each scene such as person's face, blue sky, and evening scenery, which are great elements for determining impression of the printed matter, and the scene of an image represented by image data is analyzed and the correction amount for the image is computed in accordance with the analyzing result and the target parameter, so that the image processing is executed in accordance with the correction amount for the image. The application of the auto-set up makes it possible to correct a color of an image to a color that is nice to look at, even if an operator has no skilled knowledge on the image processing, and in addition makes it possible to save one's trouble for setting up the correction amount for every image.

As mentioned above, the application of the auto-set up makes it possible to correct a color of an image to a color that is deemed to be nice generally. However, it happens that some operator would feel that “it is desired to make person's face lighter little bit”, and “a color of the sky is too light”. In such a case, in the event that an operator manually sets up over again the correction amount for the image, there is needed a skilled technique. Further, in the event that image processing is to be applied to a plurality of images, there is a need to set up the correction amount for the plurality of images. This work takes a great deal of time.

### SUMMARY OF THE INVENTION

In view of the foregoing, it is an object of the present invention to provide an image processing apparatus capable of readily correcting an image represented by image data to an image having a color shade that is nice to look at, which reflects an operator's taste, an image processing system, and an image processing program storage medium storing an image processing program, when executed in a computer, which causes the computer to operate as the image processing apparatus.

To achieve the above-mentioned objects, the present invention provides an image processing apparatus comprising:

an image data obtaining section that obtains image data;

an image analyzing section that analyzes an image represented by the image data obtained by the image data obtaining section;

an image processing section that applies image processing to the image data obtained by the image data obtaining section in accordance with an analyzing result analyzed by the image analyzing section and a processing parameter for introducing processing contents from the analyzing result; and

a parameter adjusting section that adjusts, prior to the image processing by the image processing section, the processing parameter in accordance with an operation.

According to the image processing apparatus of the present invention as mentioned above, the processing parameters are previously adjusted by an operator, and when image data is obtained, an image represented by the image data is analyzed, and the image processing is carried out in accordance with the analyzing result and the processing parameters after the adjustment. Usually, the manufacturer of an image processing apparatus prepares processing parameters reflecting the skilled know-how, and a fine adjustment of the processing parameter according to the user's wishes makes it possible for even a beginner to easily correct the image represented by the image data into an image having a desired color shade. Further, the processing parameters are adjusted prior to the image processing. Accordingly, even in the event that the image processing is applied to a plurality of image data, it is possible to reduce a trouble for setting up the correcting amount to the plurality of image data.

In the image processing apparatus according to the present invention as mentioned above, it is preferable that the image processing apparatus further comprises a saving section that saves the processing parameter adjusted by the parameter adjusting section, and

the image processing section applies the image processing according to the processing parameter save in the saving section.

The saving of processing parameters after the adjustment makes it possible to perform the image processing using the same processing parameters in the next time.

In the image processing apparatus according to the present invention as mentioned above, it is preferable that the image analyzing section analyzes a scene of the image represented by the image data to classify a predetermined plurality of scene types,

the image processing section applies the image processing to the image data obtained by the image data obtaining section in accordance with the processing parameter associated with the scene type classified by the image analyzing section,

the processing parameter is a plurality of parameters associated with the plurality of scene types, and

the parameter adjusting section individually adjusts the processing parameters.

Individual adjustment of a plurality of processing parameters associated with plurality of scene types makes it possible to correct for each scene type the color shade of an image represented by the image data.

To achieve the above-mentioned objects, the present invention provides an image processing system comprising:

an image data obtaining section that obtains image data;

an image analyzing section that analyzes an image represented by the image data obtained by the image data obtaining section;

an image processing section that applies image processing to the image data obtained by the image data obtaining section in accordance with an analyzing result analyzed by the image analyzing section and a processing parameter for introducing processing contents from the analyzing result; and

a parameter adjusting section that adjusts, prior to the image processing by the image processing section, the processing parameter in accordance with an operation.

According to the image processing system of the present invention as mentioned above, it is possible to easily correct an image represented by the image data into an image having a color shade that is nice to look at.

With respect to the image processing system, only the basic aspect is described, but the image processing system is not restricted to the basic aspect and includes various aspects corresponding to the aspects of the image processing apparatus as mentioned above.

To achieve the above-mentioned objects, the present invention provides an image processing program storage medium storing an image processing program which causes a computer to operate as an image processing apparatus, when the image processing program is executed in the computer, the image processing apparatus comprising:

an image data obtaining section that obtains image data;

an image analyzing section that analyzes an image represented by the image data obtained by the image data obtaining section;

an image processing section that applies image processing to the image data obtained by the image data obtaining section in accordance with an analyzing result analyzed by the image analyzing section and a processing parameter for introducing processing contents from the analyzing result; and

a parameter adjusting section that adjusts, prior to the image processing by the image processing section, the processing parameter in accordance with an operation.

According to the image processing program storage medium of the present invention as mentioned above, it is possible to obtain an image having a desired color shade.

Also with respect to the image processing program storage medium, only the basic aspect is described, but the image processing program storage medium is not restricted to the basic aspect and includes various aspects corresponding to the aspects of the image processing apparatus as mentioned above.

With respect to the structural elements such as the image obtaining section constituting the image processing program related to the present invention, it is acceptable that function of one structural element is implemented by one program part, function of one structural element is implemented by a plurality of program parts, or alternatively functions of a plurality structural elements are implemented by one program part. Further, it is acceptable that those structural elements are executed by oneself or by instruction to another program or program parts incorporated into a computer system.

### BRIEF DESCRIPTION OF THE DRAWINGS

FIG. 1 is an overall structural view of an input_edition_output system to which an embodiment of an image processing system of the present invention is applied.

FIG. 2 is a hardware structural view of the computer system represented by the image processing server shown in FIG. 1.

FIG. 3 is a conceptual view of a storage medium storing programs for constructing an embodiment of an image processing system of the present invention on the input_edition_output system.

FIG. 4 is a functional block diagram of an image processing system of the present invention, which is constructed on the input_edition_output system shown in FIG. 1.

FIG. 5 is a view useful for understanding scene types showing classifications of images and definitions of the scene types.

FIG. 6 is a view showing an example of an adjustment screen.

FIG. 7 is a view showing an example of a template-creating screen.

FIG. 8 is a view showing an auto set up setting screen 710 where a new template is registered.

FIG. 9 is a view showing an example of an editing screen for editing a job ticket.

FIG. 10 is a functional block diagram useful for understanding functions of an image analyzing section 12, a density obtaining section 13, and a density correcting value integration section 14.

FIG. 11 is a view useful for understanding contents of a certainty factor computing memory 21.

FIG. 12 is a flowchart useful for understanding a creating processing of the certainty factor computing memory 21.

FIG. 13 is a view useful for understanding a scheme of computation of discrimination point groups on one characteristic amount using a histogram.

FIG. 14 is a flowchart useful for understanding processing for computing the certainty factor.

FIG. 15 is a graph showing an example of a function used for computation of the certainty factor.

FIG. 16 is a flowchart useful for understanding processing for the certainty factor computation on the “person's face” of the subject sort.

FIG. 17 is an explanatory view useful for understanding creation of the integration density correcting value in the density correcting value integration section 14.

FIG. 18 is an explanatory view useful for understanding creation of the integration density correcting value in the density correcting value integration section 14.

FIG. 19 is a functional block diagram of the image processing section 15.

### DETAILED DESCRIPTION OF PREFERRED EMBODIMENTS

Embodiments of the present invention will be described with reference to the accompanying drawings.

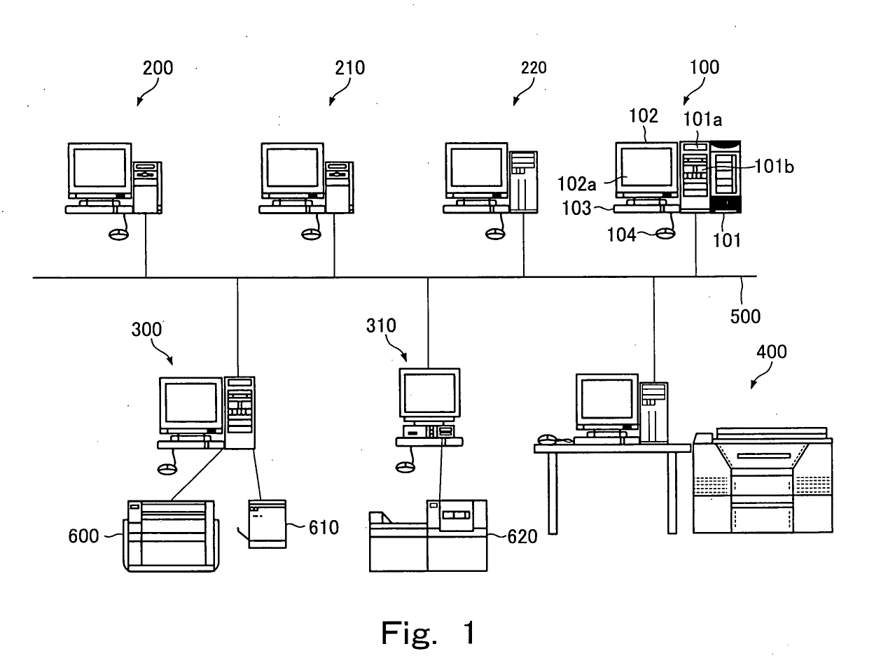

FIG. 1 is an overall structural view of an input_edition_output system to which an embodiment of an image processing system of the present invention is applied.

The input_edition_output system comprises an image processing server 100 that operates as an embodiment of an image processing apparatus of the present invention, three client machines 200, 210 and 220, two RIP (Raster Image Processor) servers 300 and 310, a scanner 400, and three image output printers 600, 610 and 620.

The image processing server 100, the client machines 200, 210 and 220, the RIP servers 300 and 310, and the scanner 400 are mutually connected to one another via a communication line 500 to constitute a LAN (Local Area Network). The printers 600 and 610 are connected to the RIP server 300. The printer 620 is connected to the RIP server 310.

The scanner 400 reads an image on a sheet to generate image data representative of the image. The generated image data is transmitted via the communication line 500 to the client machines 200, 210 and 220.

The client machines 200, 210 and 220 are each constructed of a small type of workstation or a personal computer. The client machines 200, 210 and 220 are adapted to receive image data, which is generated through reading of an original by the scanner 400, and image data based on a photographic image, which is obtained through photograph by a digital camera (not illustrated). In the client machines 200, 210 and 220, an operator performs electronically editing for individual images and a page in which elements such as characters and figures are arranged, and page data and image data, which are representative of the edited page and image, respectively, are generated. The thus generated data is transmitted via the communication line 500 to the image processing server 100.

The image processing server 100 is constructed of a workstation or a personal computer, which are larger in scale as compared with the client machines 200, 210 and 220. Upon receipt of the image data from the client machines 200, 210 and 220, the image processing server 100 applies image processing to the image data. Details of the image processing will be explained later. The image processing server 100 executes the image processing in accordance with a so-called job ticket. The client machines 200, 210 and 220 have each a function of editing the job ticket to register the edited job ticket with the image processing server 100. The image processing server 100 applies image processing according to the job ticket to individual data for the transmitted job.

By the way, the page data and the image data are such a type of data that it is impossible for an output device such as the image output printers 600, 610 and 620 to directly output the data. Hence, the data, which is subjected to the image processing, is first transmitted to the RIP servers 300 and 310, but not to the output device.

The RIP servers 300 and 310 are each constructed of a small type of workstation or a personal computer. Upon receipt of the data, which is subjected to the image processing, from the image processing server 100, the RIP servers 300 and 310 apply halftone dot conversion processing to page data and the like to convert the page data into a dot format of bit map data, which is capable of being outputted by the image output printers 600, 610 and 620. The bit map data after conversion is inputted to the image output printers 600, 610 and 620 to create output images according to the entered bit map data, respectively.

Of the individual machines constituting the input_edition_output system shown in FIG. 1, the embodiment of the present invention is applied to the image processing server 100 and the client machines 200, 210 and 220. An aspect of the embodiment of the present invention resides in processing which is executed in the individual machines, and thus hereinafter there will be explained the hardware structure of the individual machines, taking the image processing server 100 as representation.

As shown in FIG. 1, the image processing server 100 comprises, on an external appearance, a main frame unit 101, an image display unit 102 for displaying an image on a display screen 102a in accordance with an instruction from the main frame unit 101, a keyboard 103 for inputting various sorts of information to the main frame unit 101 in accordance with a key operation, and a mouse 104 for inputting an instruction according to, for example, an icon and the like, through designation of an optional position on the display screen 102a, the icon and the like being displayed on the position on the display screen 102a. The main frame unit 101 has a flexible disk mounting slot 101a for mounting a flexible disk (FD), and a CD-ROM mounting slot 101b for mounting a CD-ROM.

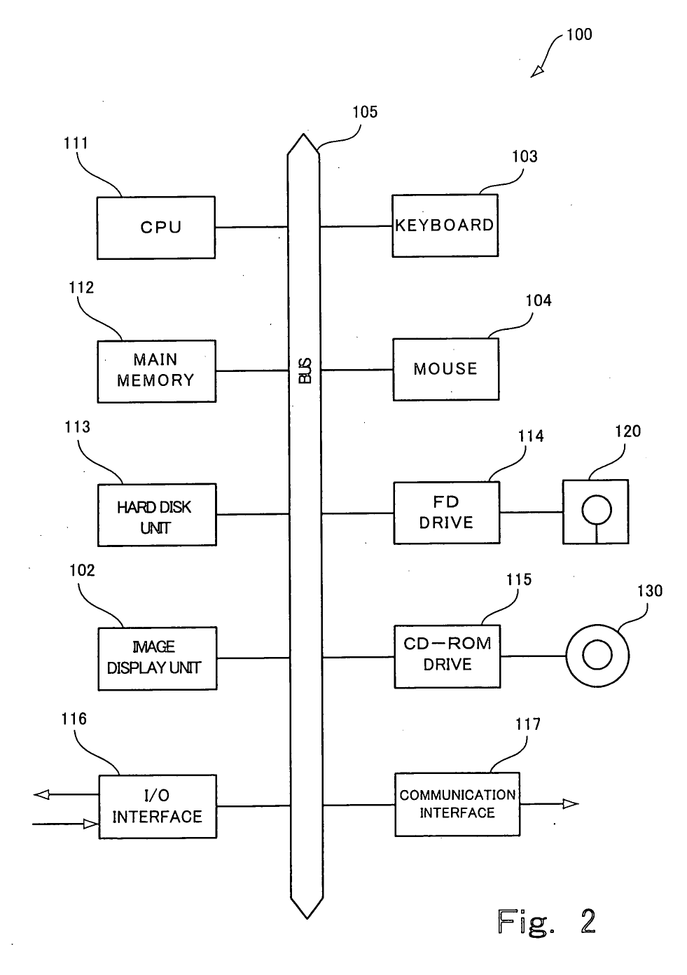

FIG. 2 is a hardware structural view of the computer system represented by the image processing server shown in FIG. 1.

The main frame unit 101 of the image processing server 100 as shown in FIG. 1 comprises, as shown in FIG. 2, a CPU 111 for executing a various types of program, a main memory 112 in which a program stored in a hard disk unit 113 is read out and developed for execution by the CPU 111, the hard disk unit 113 for saving various types of programs and data, a flexible disk drive 114 for accessing a flexible disk (FD) 120 mounted thereon, a CD-ROM drive 115 for accessing a CD-ROM 130 mounted thereon, and a communication interface 117 that controls communications with other machines, the communication interface 117 being connected to the communication line 500 of FIG. 1. These various types of elements are connected via a bus 105 to the image display unit 102, the keyboard 103 and the mouse 104.

The CD-ROM 130 stores therein individual programs for constructing an embodiment of an image processing system of the present invention on the input_edition_output system shown in FIG. 1. The CD-ROM 130 is mounted on the CD-ROM drive 115 so that the image processing program, which is stored in the CD-ROM 130, is up-loaded on the image processing server 100 and is stored in the hard disk unit 113. Further, necessary programs are downloaded via the communication line 500 onto the individual client machines 200, 210 and 220. When the individual programs, which are stored in the individual machines, are activated and executed, the input_edition_output system operates as the embodiment of the image processing system of the present invention, the individual client machines 200, 210 and 220 operate as the job ticket editing apparatus which corresponds to an example of the parameter control section referred to in the present invention, and the image processing server 100 operates as the embodiment of the image processing apparatus of the present invention, which also serves as the job ticket editing apparatus. Incidentally, it is noted that a scheme of introducing the programs into the individual client machines 200, 210 and 220 is not restricted to the scheme of downloading via the communication line 500, as shown by way of example here. It is acceptable, for example, to adopt a scheme of storing programs into CD-ROM to be directly up-loaded on the individual client machines 200, 210 and 220.

Hereinafter, there will be explained the individual programs for constructing the embodiment of an image processing system of the present invention on the input_edition_output system.

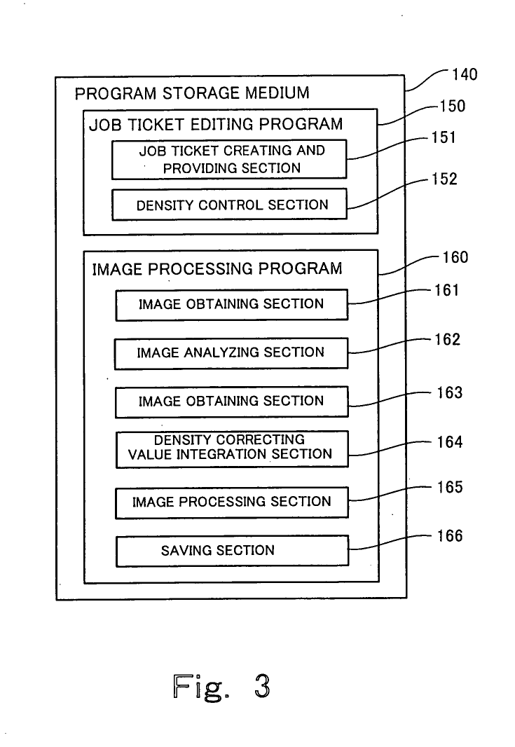

FIG. 3 is a conceptual view of a storage medium storing programs for constructing an embodiment of an image processing system of the present invention on the input_edition_output system.

Program storage medium 140 shown in FIG. 3 is not restricted to a sort of medium. For example, when the program is stored in a CD-ROM, the program storage medium 140 denotes the CD-ROM. When the program is stored in a hard disk unit through loading, the program storage medium 140 denotes the hard disk unit. When the program is stored in a flexible disk, the program storage medium 140 denotes the flexible disk.

As mentioned above, according to the present embodiment, the program storage medium 140 stores a job ticket editing program 150 that causes the image processing server 100 and the client machines 200, 210 and 220 to operate as the job ticket editing apparatus, and an image processing program 160 that causes the image processing server 100 to operate as the image processing apparatus of the present invention.

The job ticket editing program 150 comprises a job ticket creating and providing section 151 and a density control section 152. The image processing program 160 comprises an image obtaining section 161, an image analyzing section 162, a density obtaining section 163, a density correcting value integration section 164, an image processing section 165, and a saving section 166.

Details of the individual elements of the programs 150 and 160 will be explained later.

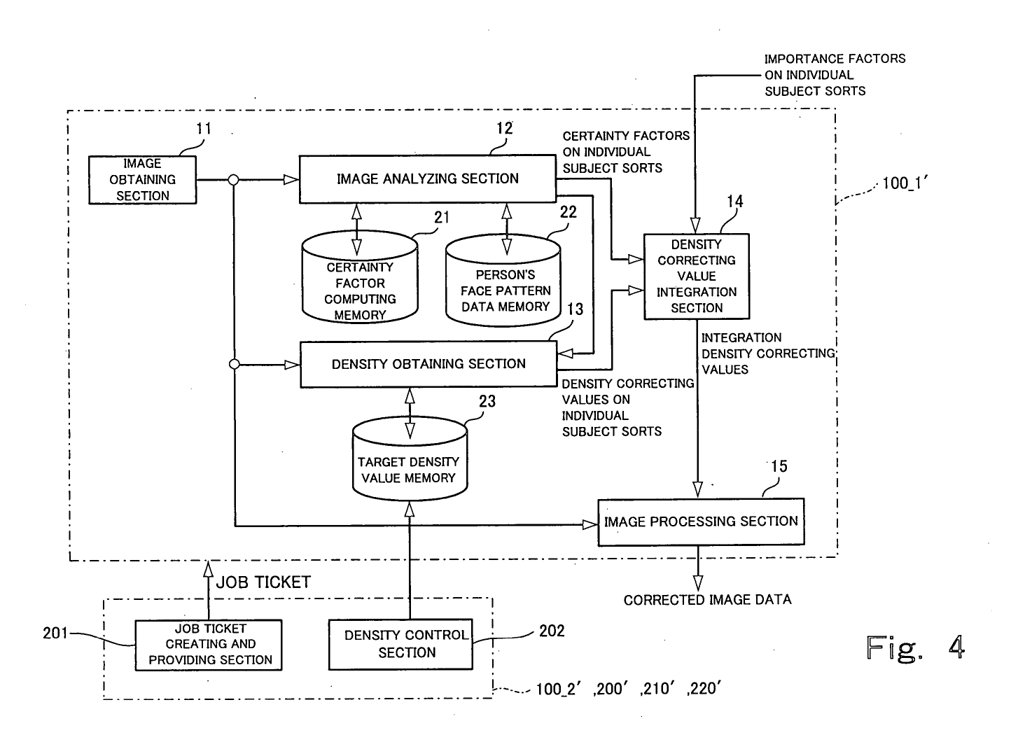

FIG. 4 is a functional block diagram of an image processing system of the present invention, which is constructed on the input_edition_output system shown in FIG. 1.

FIG. 4 shows an image processing system comprises an image processing apparatus 100_1′ and job ticket editing apparatuses 100_2′, 200′, 210′, and 220′. The image processing apparatus 100_1′ is constructed when the image processing program 160 shown in FIG. 3 is installed in the image processing server 100 shown in FIG. 1 and be executed. The job ticket editing apparatuses 100_2′, 200′, 210′, and 220′ are constructed when the job ticket editing program 150 shown in FIG. 3 is installed in the image processing server 100 shown in FIG. 1 and the client machines 200, 210 and 220 and be executed.

The image processing apparatus 100_1′ shown in FIG. 4 comprises an image obtaining section 11, an image analyzing section 12, a density obtaining section 13, a density correcting value integration section 14, an image processing section 15, a certainty factor computing memory 21, a person's face pattern data memory 22, and a target density value memory 23. When the image processing program 160 shown in FIG. 3 is installed in the image processing server 100 shown in FIG. 1, the image obtaining section 161 of the image processing program 160 constitutes the image obtaining section 11 of the image processing apparatus 100_1′. In a similar fashion, the image analyzing section 162 constitutes the image analyzing section 12, the density obtaining section 163 constitutes the density obtaining section 13, the density correcting value integration section 164 constitutes the density correcting value integration section 14, the image processing section 165 constitutes the image processing section 15, and the saving section 166 constitutes the certainty factor computing memory 21, the person's face pattern memory 22, and the target density value memory 23.

The job ticket editing apparatuses 100_2′, 200′, 210′, and 220′ shown in FIG. 4 comprise each a job ticket creating and providing section 201 and a density control section 202. When the job ticket editing program 150 shown in FIG. 3 is installed in the image processing server 100 and the client machines 200, 210 and 220, the job ticket creating and providing section 151 of the job ticket editing program 150 constitutes the job ticket creating and providing section 201 of the job ticket editing apparatuses 100_2′, 200′, 210′, and 220′, and the density control section 202 constitutes the density control section 152.

The elements of the image processing program 160 shown in FIG. 3 and the elements of the job ticket editing program 150 correspond to the elements of the image processing apparatus 100_1′ shown in FIG. 4 and the elements of the job ticket editing apparatuses 100_2′, 200′, 210′, and 220′ shown in FIG. 4, respectively. While the individual elements shown in FIG. 4 are constructed with a combination of hardware of a computer system and OS and application programs, which are executed in the computer system, the individual elements shown in FIG. 3 are constructed with only the application programs.

The image obtaining section 11 of the image processing apparatus 100_1′ corresponds to the example of the image obtaining section referred to in the present invention. The image analyzing section 12 corresponds to the example of the image analyzing section referred to in the present invention. The image processing section 15 corresponds to the example of the image processing section referred to in the present invention. The target density value memory 23 corresponds to the example of the saving section referred to in the present invention. The density control section 202 of the job ticket editing apparatuses 100_2′, 200′, 210′, and 220′ corresponds to the example of the density control section referred to in the present invention.

Hereinafter, there will be explained the individual elements shown in FIG. 4 in conjunction with the individual elements of the programs 150 and 160 shown in FIG. 3.

According to the job ticket editing apparatuses 100_2′, 200′, 210′, and 220′, in the image processing of the image processing apparatus 100_1′, there is edited a job ticket that describes an input folder for storing input image data, parameters used for image processing, image processing procedure, an output folder for storing image data subjected to image processing. The image processing apparatus 100_1′ applies image processing to image data in accordance with the job ticket edited by the job ticket editing apparatuses 100_2′, 200′, 210′, and 220′. According to the present embodiment, the image processing apparatus 100_1′ has an auto set up function of analyzing subject sorts (scenes) of an image represented by image data so that a color of the image is corrected to the target density that is previously stored for each subject sort.

Mice and keyboards of the client machines 200, 210 and 220 serve as the density control section 202, which constitutes the job ticket editing apparatuses 100_2′, 200′, 210′, and 220′. The density control section 202 serves to adjust the target density value every the subject sort of an image, which is previously stored in the target density value memory 23 of the image processing apparatus 100_1′, and sets up a new target density value. The new target density value thus set up is stored in the target density value memory 23.

The job ticket creating and providing section 201, which constitutes the job ticket editing apparatuses 100_2′, 200′, 210′, and 220′, edits a job ticket in accordance with operation of an operator and transmits the edited job ticket to the image processing apparatus 100_1′ to request of the image processing apparatus 100_1′ to execute the image processing. The job tickets transmitted from the job ticket editing apparatuses 100_2′, 200′, 210′, and 220′ are registered in a register memory (not illustrated) of the image processing apparatus 100_1′.

The image obtaining section 11 of the image processing apparatus 100_1′ obtains input image data from an input folder described in the job ticket, when the job ticket is transmitted. The obtained input image data is fed to the image analyzing section 12, the density obtaining section 13, and the image processing section 15.

The image analyzing section 12 computes, for each subject sort, a certainty factor representative of a ratio as to how the input image represented by the given input image data includes a predetermined plurality of subject sort. The image analyzing section 12 is connected to the certainty factor computing memory 21 and the person's face pattern memory 22. The image analyzing section 12 computes the certainty factor for each subject sort included in the input image represented by the given input image data, using the data stored in the certainty factor computing memory 21 and the person's face pattern memory 22. There will be described later the certainty factor computing processing of the image analyzing section 12, and the certainty factor computing memory 21 and the person's face pattern memory 22.

The density obtaining section 13 is a circuit for computing values (density correcting values) for correcting density of input images in accordance with input image data. The density obtaining section 13 is connected to the target density value memory 23 that stores the target density values on the plurality of subject sorts as mentioned above. The density obtaining section 13 computes density correcting values for each subject sort in accordance with the target density values on the plurality of subject sorts stored in the target density value memory 23. Details of the processing of the density obtaining section 13 will be described later.

The density correcting value integration section 14 is a circuit for integrating the density correcting values for each subject sort, which are computed by the density obtaining section 13, in accordance with the certainty factors for each subject sort, which are computed by the image analyzing section 12, and degree of importance for each subject sort, which is entered from the client machines 200, 210 and 220. The density correcting value integration section 14 computes the integrated density correcting value in which the density correcting value as to the subject sort that is large in certainty factor is greatly reflected, and the density correcting value as to the subject sort that is large in degree of importance is greatly reflected. Details of processing of the density correcting value integration section 14 will be described later.

The image processing section 15 corrects density of the input image data in accordance with the integrated density correcting value computed by the density correcting value integration section 14. Image data, which is corrected in density by the image processing section 15, is transmitted from the image processing apparatus 100_1′ via the communication interface 117 shown in FIG. 2 to the RIP servers 300 and 310. The image output printers 610 and 620 print out images according to the image data thus obtained.

The image processing apparatus 100_1′ and the job ticket editing apparatuses 100_2′, 200′, 210′, and 220′, which are shown in FIG. 4, are basically constructed as mentioned above.

Hereinafter, there will be explained a series of processing in which the auto set up applies image processing to image data.

The auto set up has a function of analyzing as to what scene type an image represented by image data is classified to among a plurality of scenes (subject sorts), and automatically executing image processing according to the scene type.

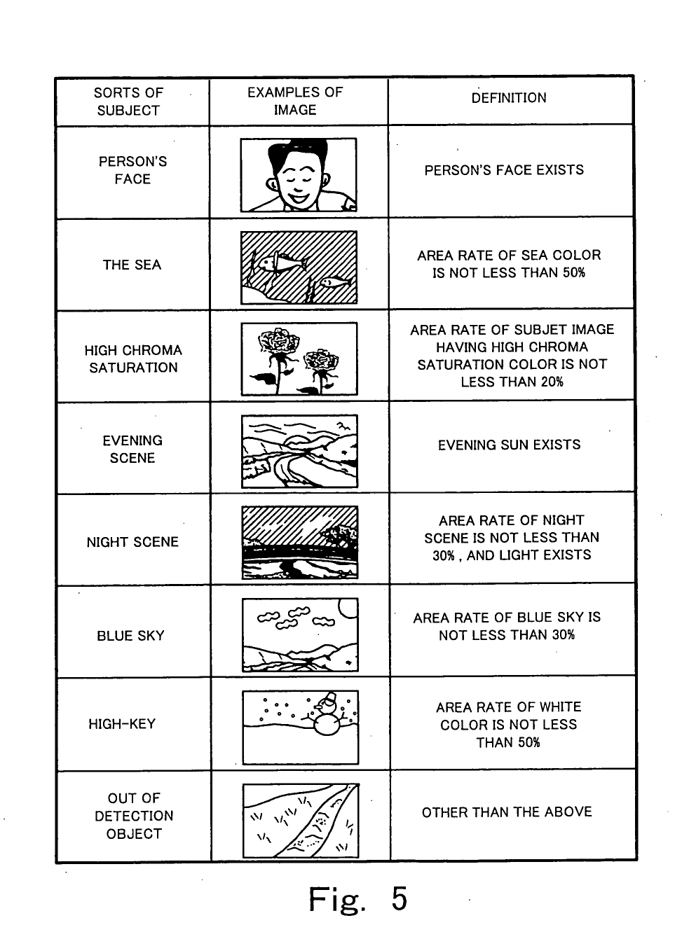

FIG. 5 is a view useful for understanding scene types showing classifications of images and definitions of the scene types.

As shown in FIG. 5, according to the present embodiment, it is analyzed as to into which subject sort images represented by image data are classified among subject sorts “person's face”, “the sea”, “high chroma saturation”, “evening scene”, “night scene”, “blue sky”, “high-key”, and “out of detection object”. Incidentally, according to the present embodiment, when it is analyzed that ah image is classified into a plurality of subject sorts among the subject sorts shown in FIG. 5, it is computed as to at what degree of certainty factor the subject sort is included, and the image processing is carried out in accordance with the certainty factor.

The target density value memory 23 shown in FIG. 4 stores target density values for the plurality of subject sorts shown in FIG. 5. When the auto set up is carried out in accordance with the target density values stored in the target density value memory 23, the image is corrected to an image having a color that is nice to look at generally. However, some operator would have such an impression that as to the image represented by the image data after the auto set up, “the person's face should be lighter”. According to the image processing system of the present embodiment, the auto set up function is carried out to satisfy an operator's wish.

First, before the image processing is carried out, the target density values stored in the target density value memory 23 are adjusted beforehand. The job ticket editing apparatuses 100_2′, 200′, 210′, and 220′ have each an adjustment screen for adjusting the target density values, and an icon for activating the control screen. When an operator uses the mouse and the like to select an icon, there is displayed the adjustment screen on the display screen of the job ticket editing apparatuses 100_2′, 200′, 210′, and 220′.

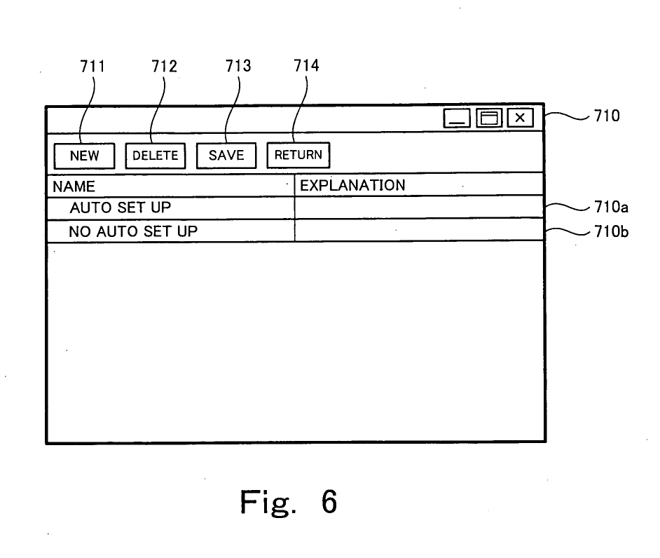

FIG. 6 is a view showing an example of the adjustment screen.

A template display screen 710 is provided with an auto set up selection section 710a for executing auto set up processing in accordance with target density values of default associated with the plurality of subject sorts (“person's face”, “the sea”, “high chroma saturation”, “evening scene”, “night scene”, “blue sky”, “high-key”, and “out of detection object”), an auto set up releasing section 710b for releasing the auto set up processing; a new registration button 711 for registering a new template, a deletion button 712 for deleting the template, a saving button 713 for saving the template, and a button 714 for returning a screen to the previous screen. When the new registration button 711 is selected in the state that the auto set up selection section 710a is selected, it is possible to create a new template in accordance with “default template” in which the target density values of default are assembled. When the auto set up releasing section 710b is designated, the auto set up processing is not executed, and there is displayed a correcting amount set up screen for setting up a correcting amount for an image every image (not illustrated). When an operator uses the correcting amount set up screen to individually set up the correcting amount while confirming an image, it is possible to execute the image processing that surely reflects an operator's wish. However, the work of setting up an correcting amount for executing a desired image processing needs a skilled technology, and in addition there is a need to set up one by one an correcting amount for each image. This work takes a great deal of time. According to the present embodiment, an adjustment of the target density values to be used for the auto set up processing prior to the image processing makes it possible to execute the auto set up processing, while reflecting the operator's wish.

When an operator selects, using the mouse and the like, the auto set up selection section 710a and the new registration button 711, there is displayed a template-creating screen for creating a new template in accordance with the “default template”.

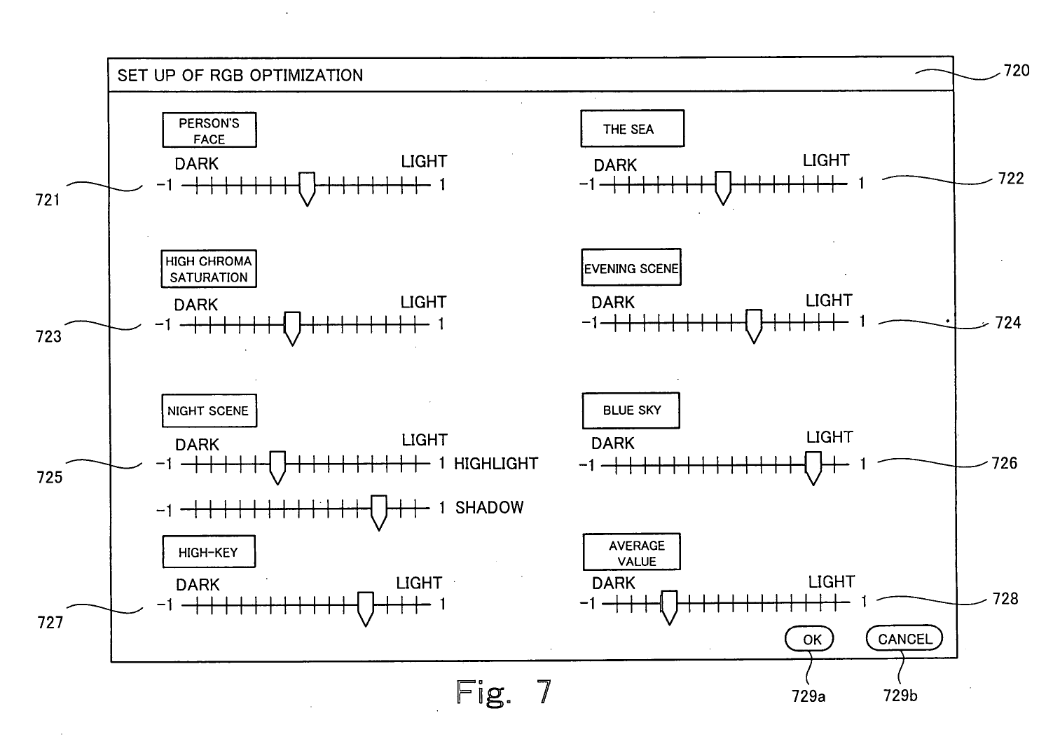

FIG. 7 is a view showing an example of a template-creating screen.

A template-creating screen 720 is provided with a person's face adjustment section 721 for adjusting the target density value of the “person's face”, a sea adjustment section 722 for adjusting the target density value of “the sea”, a high chroma saturation adjustment section 723 for adjusting the target density value of “high chroma saturation”, an evening scene adjustment section 724 for adjusting the target density value of “evening scene”, a night scene adjustment section 725 for adjusting the target density value of “night scene”, a blue sky adjustment section 726 for adjusting the target density value of “blue sky”, a high-key adjustment section 727 for adjusting the target density value of “high-key”, and an out of object adjustment section 728 for adjusting the target density value of “out of detection object”. Further, the template-creating screen 720 is provided with an OK button 729a for settling the target density value adjusted by the respective adjustment section, and a cancel button 729b for canceling the adjustment of the target density value. The respective adjustment section has a scale and a handler. When the handler indicates the center of the scale, there is set up the target density value in the “default template” that is previously prepared. For example, when it is desired that “only the person's face grows lighter as compared with the usual auto set up”, an operator moves the handler of the person's face adjustment section 721 to the “light” side, and selects the OK button 729a.

When the OK button 729a is selected, the density control section 202 shown in FIG. 4 obtains, on the template-creating screen 720 shown in FIG. 7, a plurality of density set up values associated with a plurality of subject sorts according to the positions indicated by the handlers of the respective adjustment sections. Those density set up values are assembled in form of a single new “template 1” to be registered in the target density value memory 23 of the image processing apparatus 100_1′ shown in FIG. 4.

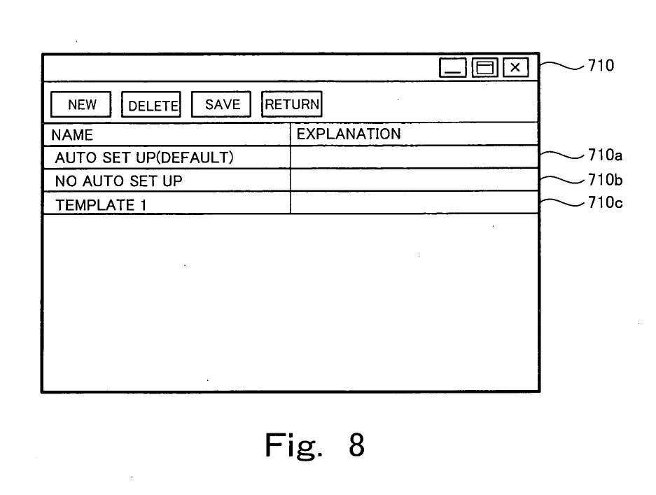

FIG. 8 is a view showing an auto set up setting screen 710 where a new template is registered.

As shown in FIG. 8, on the auto set up setting screen 710, there are displayed a template 1 selection section 710c that executes the auto set up using the newly registered “template 1”, as well as the auto set up selection section 710a also shown in FIG. 6 and the auto set up releasing section 710b. When the template 1 selection section 710c is selected, the set up content of the “template 1” shown in FIG. 7 is displayed, so that the set up content of the “template 1” can be revised. When the new registration button 711 is selected in a state that the template 1 selection section 710c is designated, there is displayed the template-creating screen 720 for creating a new template in accordance with the template 1.

As mentioned above, when an operator adjusts the density target value of the default that is prepared beforehand, it is possible to easily set up a parameter for executing image processing that reflects the operator's wish, even if the operator has no detailed knowledge of the image processing. Further, saving of the template after the adjustment makes it possible also next to perform the image processing through using the same template.

When image processing is actually applied to an image, an operator uses the job ticket editing apparatuses 100_2′, 200′, 210′, and 220′ to edit job tickets so that the edited job tickets are registered onto the image processing apparatus 100_1′.

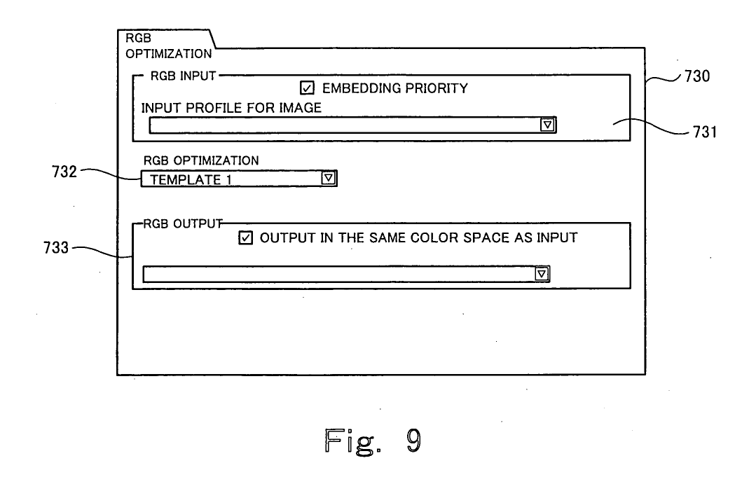

FIG. 9 is a view showing an example of an editing screen for editing a job ticket.

When an operator selects an icon prepared on the job ticket editing apparatuses 100_2′, 200′, 210′, and 220′, a job ticket editing screen 730 is displayed on the display screens of the job ticket editing apparatuses 100_2′, 200′, 210′, and 220′. The job ticket editing screen 730 is provided with an input profile designation section 731 for designating an input profile to convert a color space of input image data, an output profile designation section 733 for designating an output profile to convert a color space of output image data, and an image processing designation section 732 for designating the auto set up presence and the template used in image processing. The image processing designation section 732 is able to select three image processing states (the auto set up using “default template”, no auto set up, and the auto set up using “template 1”) shown in FIG. 8.

An operator selects “the auto set up using template 1” through the image processing designation section 732, and designates a path of an input folder for storing input image data and a path of an output folder for storing output image data subjected to image processing on a folder selection screen (not illustrated). As a result, the job ticket creating and providing section 201 shown in FIG. 4 creates the job ticket that describes the path of the input folder, the path of the output folder, and the indication of “the auto set up using template 1”. The created job ticket is registered with the image processing apparatus 100_1′.

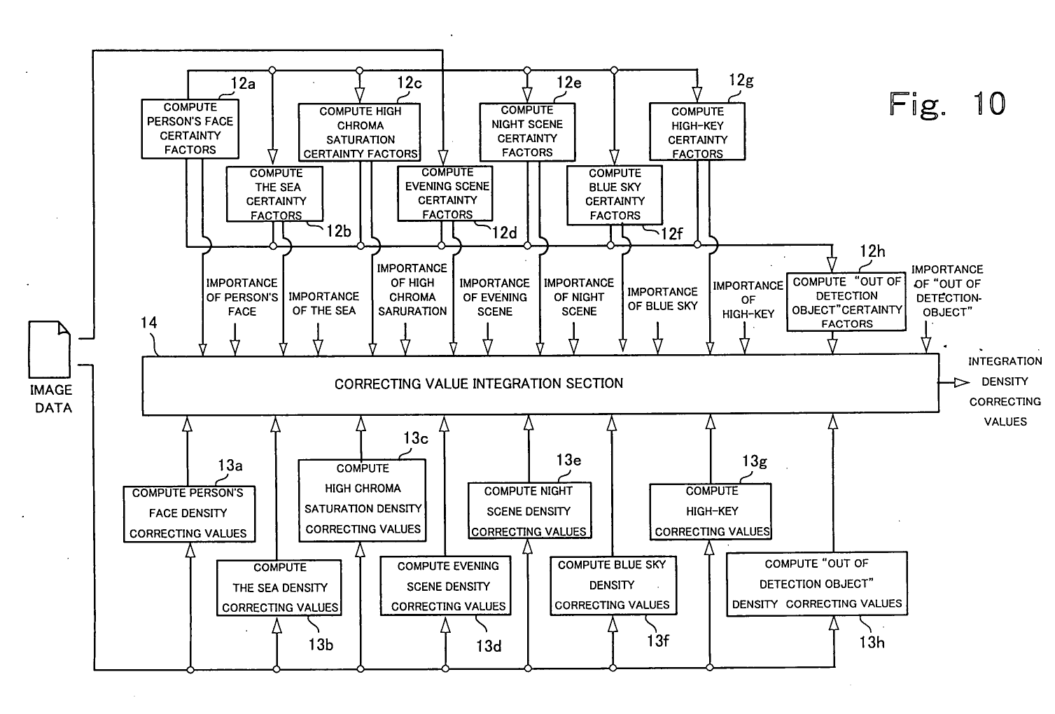

FIG. 10 is a functional block diagram useful for understanding functions of the image analyzing section 12, the density obtaining section 13, and the density correcting value integration section 14.

When the job ticket is registered, the image obtaining section 11 of the image processing apparatus 100_1′ obtains input image data from the input folder described in the job ticket, and feeds the input image data to the image analyzing section 12, the density obtaining section 13, and the image processing section 15.

The image analyzing section 12 analyzes whether the input image represented by the image data fed from the image obtaining section 11 includes an image portion representative of any one of seven sorts of subjects of “person's face”, “the sea”, “high chroma saturation”, “evening scene”, “night scene”, “blue sky”, and “high-key”. When it is decided that the input image represented by the image data fed from the image obtaining section 11 includes such an image portion, the image analyzing section 12 computes the certainty factor of an inclusion of the input image (function blocks 12a to 12g). The image analyzing section 12 detects the fact that the input image includes none of the seven sorts of subjects, and computes the certainty factor of that (the certainty factor of the subject sort “out of detection object”)(function block 12h). In other words, the image analyzing section 12 discriminates or detects whether the input image includes an image portion representative of any one of eight sorts of subjects of “person's face”, “the sea”, “high chroma saturation”, “evening scene”, “night scene”, “blue sky”, “high-key”, and “out of detection object”. When it is decided that the input image includes such an image portion, the image analyzing section 12 computes the certainty factor of an inclusion of the input image. As to details of the processing for the computation of the certainty factor of an inclusion of the input image, it will be described later.

The density obtaining section 13 first obtains the “template 1” described in the job ticket, of a plurality of templates saved in the target density value memory 23. Next, the density obtaining section 13 computes density correcting values for the subject sorts wherein the certainty factor is computed in the image analyzing section 12, in accordance with the input image. In other words, the density obtaining section 13 computes density correcting values for eight sorts of subjects of “person's face”, “the sea”, “high chroma saturation”, “evening scene”, “night scene”, “blue sky”, “high-key”, and “out of detection object” in accordance with the density target value included in the “template 1” (function block 13a to 13h).

The density correcting value integration section 14 integrates the density correcting values for the subject sorts computed in the density obtaining section 13 (function block 13a to 13h) in accordance with the certainty factor for the subject sorts computed by the image analyzing section 12 (function blocks 12a to 12h), and a degree of importance for the subject sorts entered from the client machines 200, 210 and 220, and computes a single density correcting value (an integrated density correcting value) (function block 14a).

The integrated density correcting value is expressed by a functional expression representative of the output density value associated with the input density value. An integrated density correcting value T(s) (where s denotes input density value: variable) is expressed by the following equation 1.
T(s)=Σ(SiViTi(s)) (Equation 1)

Where variable i denotes the subject sorts “person's face”, “the sea”, “high chroma saturation”, “evening scene”, “night scene”, “blue sky”, “high-key”, and “out of detection object”. Si denotes a degree of importance for the subject sort to be entered by an operator of the image processing system as mentioned above. Ti(s) denotes the density correcting values for the subject sorts computed in the density obtaining section 13. Vi denotes weight for the subject sorts, which are obtained in accordance with the certainty factors for the subject sorts, which are obtained by the image analyzing section 12. The weight Vi is computed in accordance with the following equation 2.
Vi=Pi/Σ(Pi) (Equation 2)

Also in Equation 2, the variable i denotes the subject sorts “person's face”, “the sea”, “high chroma saturation”, “evening scene”, “night scene”, “blue sky”, “high-key”, and “out of detection object”. Pi denotes the certainty factors for the subject sorts computed by the image analyzing section 12.

As seen from the equation 1 and the equation 2, the integrated density correcting value T(s) is obtained in such a manner that the weight Vi and the degree Si of importance for the subject sort to be entered by an operator are multiplied by the density correcting values Ti(s), and the individual items are summed up. Hence, the integrated density correcting value T(s) greatly reflects the density correcting values for the subject sorts, which are large in certainty factor, and greatly reflects the density correcting values for the subject sorts, which are large in the given (set up) degree of importance.

Next, there will be described details of processing of the image analyzing section 12.

According to the present embodiment, of eight sorts of subjects of “person's face”, “the sea”, “high chroma saturation”, “evening scene”, “night scene”, “blue sky”, “high-key”, and “out of detection object”, which are to be computed in certainty factor, the subject sorts “person's face” and “out of detection object” are computed in certainty factor in a way different from other subject sorts (“the sea”, “high chroma saturation”, “evening scene”, “night scene”, “blue sky”, and “high-key”). There will be described later the certainty computing processing for the subject sorts “person's face” and “out of detection object”. First, there will be described the certainty computing processing for the subject sorts “the sea”, “high chroma saturation”, “evening scene”, “night scene”, “blue sky”, and “high-key”.

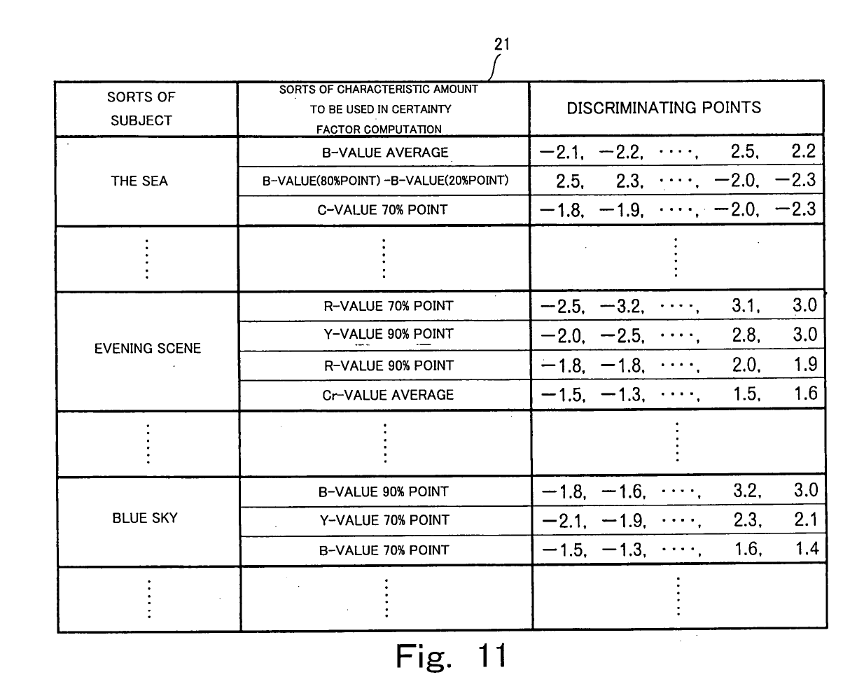

FIG. 11 is a view useful for understanding contents of a certainty factor computing memory 21, which are used for the computation of the certainty factors for the subject sorts by the image analyzing section 12, excepting the certainty factors for the subject sorts “person's face” and “out of detection object”.

The a certainty factor computing memory 21 stores therein sorts of an amount of characteristic to be used in computation of the certainty factor and discrimination points for individual characteristic amount sorts (an assembly of a plurality of discrimination points) (hereinafter, which are referred to as a discrimination point group), in association with the subject sorts (for example, six sorts of “the sea”, “high chroma saturation”, “evening scene”, “night scene”, “blue sky”, and “high-key”) excepting the subject sorts “person's face” and “out of detection object”, which are computed in certainty factor by the image analyzing section 12.

As the sorts of characteristic amount to be used in certainty factor computation, generally, a plurality of characteristic amounts of sorts is associated with a single subject sort. For example, referring to FIG. 11, the certainty factor computing memory 21 stores, as the sorts of characteristic amount to be used in certainty factor computation for the subject sort “the sea”, “B-value average”, “B-value (80% point)−B-value (20% point)”, and “Cb-value 70% point”. This indicates that three types of characteristic amount of: (1) the average value of B-values of pixels constituting the input image (“B-value average”); (2) the value wherein in the cumulative histogram of B-values of pixels constituting the input image, B-value associated with 20% point is subtracted from B-value associated with 80% point (“B-value (80% point)−B-value (20% point)”); and (3) in the cumulative histogram of Cb-values of pixels constituting the input image, the Cb-value associated with 70% point (“Cb-value 70% point”), are established as the sorts of characteristic amount to be used in certainty factor computation for the subject sort “the sea”.

The discrimination point group is an assembly of the discrimination points for computation of the certainty factor. Details of the discrimination point group will be clarified in conjunction with the explanation of creation processing for the certainty factor computing memory 21, which will be described hereinafter.

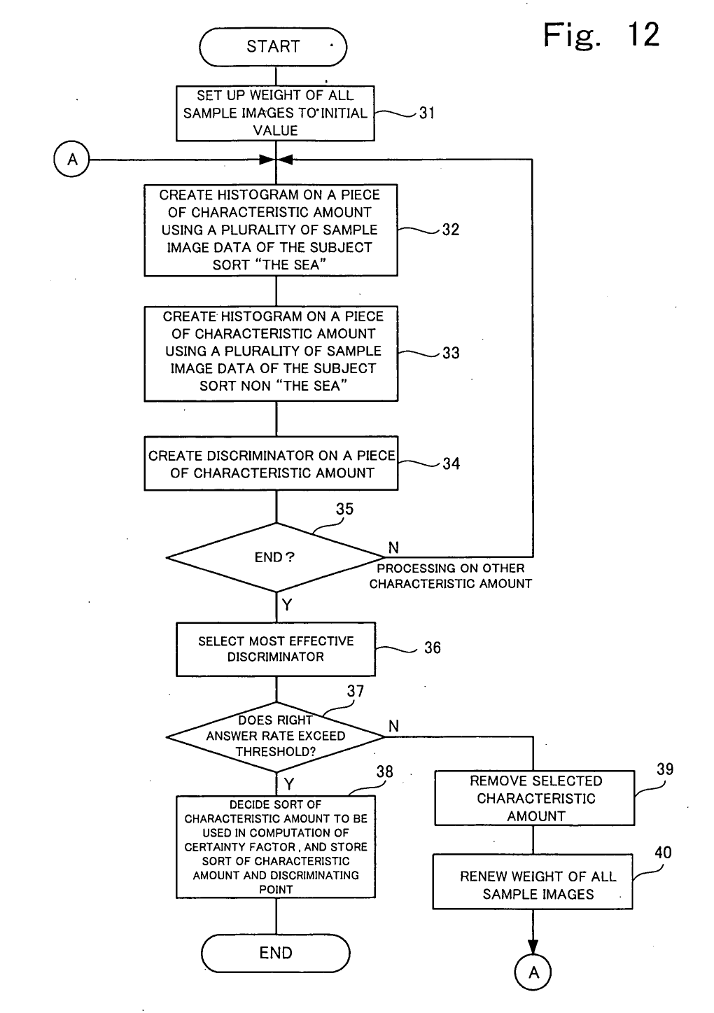

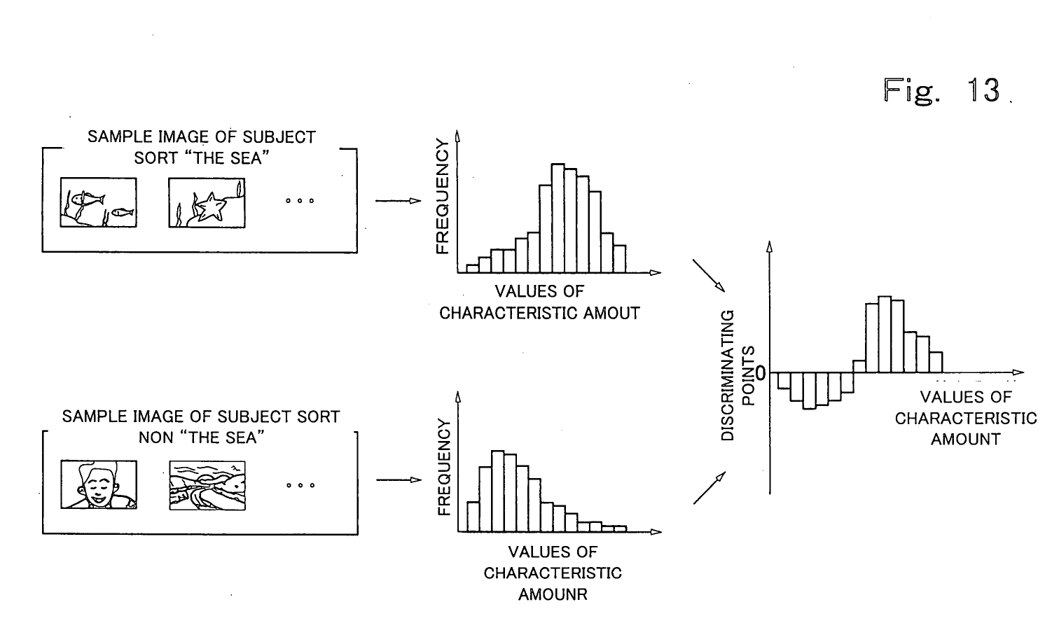

With respect to the creation processing for the certainty factor computing memory 21, it will be explained in conjunction with FIG. 12 and FIG. 13.

FIG. 12 is a flowchart useful for understanding a creating processing of the certainty factor computing memory 21. FIG. 13 is a view useful for understanding a scheme of computation of discrimination point groups on one characteristic amount using a histogram.

The certainty factor computing memory 21 stores therein, as mentioned above, sorts of an amount of characteristic to be used in computation of the certainty factor and the discrimination point group associated with the sorts of an amount of characteristic in association with the subject sorts excepting the subject sorts “person's face” and “out of detection object”. The following learning processing performs the creation of the certainty factor computing memory 21.

Taking the subject sort “the sea” by way of example, there will be explained the learning processing, that is, computing processing for sorts of an amount of characteristic to be used in computation of the certainty factor and the computing processing for the discrimination point group associated with the sorts of the characteristic amounts.

There are prepared a large number of sample image data to be an object of learning. The prepared large number of sample image data is distinguished between a sample image to be addressed as the subject sort “the sea”, that is, referring to FIG. 5, an image wherein an area rate of the sea color is not less than 50%, (hereinafter, it is referred to as “the sea sample image”), and a sample image to be addressed as not “the sea” in the subject sort, that is, an image in which no sea color exists, or an area rate of the sea color is less than 50%, (hereinafter, it is referred to as “none sea sample image”). This state is shown at the left side of FIG. 13.

Weight is applied to all the sample images to be an object of learning, that is, all the sea sample images and none sea sample images. First, the weight to be applied to all the sample images is set up to the initial value (for example, “1”) (step S31).

A plurality of sea sample image is used to create a cumulative histogram on a piece of characteristic amount (step 32: a creation of a histogram shown upper center of FIG. 13). For example, “B-value average”, which is one of the characteristic amount sorts, is selected, and there is created a cumulative histogram on the selected characteristic amount sort “B-value average”.

Likely, a plurality of none sea sample image is used to create a cumulative histogram on one characteristic amount sort (in case of the above example, “B-value average”) (step 33: a creation of a histogram shown lower center of FIG. 13).

A cumulative histogram on one characteristic amount sort, which is created using a plurality of sea samples, and a cumulative histogram on one characteristic amount sort, which is created using a plurality of none sea samples, are used to compute a logarithmic value of a ratio of frequency value for each associated characteristic amount value. One wherein the computed logarithmic value is expressed by a histogram is the histogram shown at the right side of FIG. 13 (hereinafter, it is referred to as a discriminator). The discriminator is an assembly of logarithmic values associated with the characteristic amount values at regular intervals.

In the discriminator shown at the right side of FIG. 13, values (the above-mentioned logarithmic values) of the vertical axis denote “discriminating points” (cf. FIG. 11). As will be described later, the image analyzing section 12 computes characteristic amount on the given input image data, and computes the discriminating point associated with the computed characteristic amount using the discriminator (the certainty factor computing memory 21). The input image having the value of the characteristic amount associated with the positive discriminating point is involved in a high possibility that the subject sort should be “the sea”. The more absolute value is involved in the higher possibility. Reversely, the input image having the value of the characteristic amount associated with the negative discriminating point is involved in a high possibility that the subject sort is not “the sea”. The more absolute value is involved in the higher possibility.

In a similar fashion to that as mentioned above, there are created the discriminators on other characteristic amount sorts, for example, G-value average, B-value average, luminance Y average, color difference Cr average, color difference Cb average, chroma saturation average, color-phase average, a plurality of n % points, and a plurality of (m % points)−(n % points) (step 35: No, step 32 to step 34). That is, there is created a plurality of discriminators associated with a plurality of characteristic amount sorts, respectively.

Of the plurality of discriminators thus created, there is selected a discriminator that is most effective for deciding that it is concerned with an image of the subject sort “the sea” (step 36). In order to select the most effective discriminator, there is computed a right answer rate. The right answer rate is computed in accordance with the following equation 3.
Right answer rate=the number of right answer sample images/the number of all sample images (Equation 3)

As mentioned above, the sea sample image and the non-sea sample image are separated beforehand. For example, regarding a sea sample image A, a piece of characteristic amount is computed, and a discrimination point associated with the computed characteristic amount is obtained by a discriminator associated with a sort of a piece of characteristic amount as mentioned above. If the discrimination point offers a positive value, it is understood that the discriminator can properly interpret the sea sample image A (the right answer sample image). Thus, the number of right answer sample images is incremented. Reversely, if a discrimination point, which is associated with a piece of characteristic amount computed on a sea sample image B, offers a negative value, it is understood that the discriminator cannot properly interpret the sea sample image B (the erroneous answer sample image).

With respect to the non-sea sample image, if a discrimination point, which is associated with a piece of characteristic amount computed, offers a negative value, it is understood that the discriminator can properly interpret the sample image (the right answer sample image). Thus, the number of right answer sample images is incremented. If the discrimination point offers a positive point, it is understood that the discriminator can properly interpret the sample image (the erroneous answer sample image).

The above-mentioned right answer rate is computed on individual one of a plurality of discriminators, which is created in association with a plurality of sorts of characteristic amount, and one, which offers the highest right answer rate, is selected as the most effective discriminator.

Next, it is decided whether the right answer rate exceeds a predetermined threshold (step 37). When it is decided that the right answer rate exceeds the predetermined threshold (“YES” in the step 37), the use of the selected discriminator makes it possible to be understood that the subject sort “the sea” can be selected at the sufficiently high possibility, so that the learning processing is terminated. The characteristic sort associated with the selected discriminator, and the discrimination point group (an assembly of discrimination points associated with values of characteristic amount at regular intervals) in the selected discriminator is stored in the certainty factor computing memory 21 (step 38).

In the event that the computed right answer rate is less than a predetermined threshold (“NO” in the step 37), the following processing is performed.

First, the characteristic amount sort selected in the above-mentioned processing is removed from the processing object (step 39).

Next, weights of all the sample images are renewed (step 40).

As to renewal of weight of the sample images, weights of individual sample images are renewed in such a manner that of the all sample images, weights of sample images (erroneous answer sample images) involved in no right answer result are high, and weights of sample images (right answer sample images) involved in the right answer result are low. The reason why this is to do so is that images, which are properly judged by the selected discriminators, are regarded as important, so that those images can be properly judged. It is sufficient for a renewal of the weight that weights of the erroneous answer sample images vary relatively with respect to weights of the right answer sample images. Thus, it is acceptable to adopt only either one of the renewal in which weights of the erroneous answer sample images is high, and the renewal in which weights of the right answer sample images is low.

The use of the sample images renewed in weight makes it possible to create over again discriminators on individual characteristic amount sorts excepting the removed characteristic amount sorts (step 32 to step 35).

According to the processing for the creating of the cumulative histogram in the processing for the creating of the discriminators following the second time (step 32 and step 33), weights applied to individual sample images are used. For example, if weight applied to a certain sample image is “2”, histograms (histograms at upper stage and lower stage of the center of FIG. 13), which are created by the sample image, are twice in frequency.

Of the newly created discriminators, the most effective discriminator is selected (step 36). Also in the selection processing for the most effective discriminator following the second time, there is used weight applied to the sample image. For example, if weight applied to a certain sample image is “2”, in the event that the right answer result is obtained on the sample image, “2” but not “1” is added to the number of right answer sample image, in the equation 3. Thus, there is put emphasis on a point that the sample image, which is high in weight, is properly discriminated, rather than the sample image, which is low in weight.

The right answer rate for the discriminator selected as the most effective discriminator in the first processing is added to the right answer rate for the discriminator selected as the most effective discriminator in the second processing. In the event that the added right answer rate exceeds a predetermined threshold, the two discriminators are regarded as discriminators for discriminating the subject sort “sea”.

In the event that the right answer rate is less than the predetermined threshold, the similar processing is repeated (NO in the step 37, the step 39, the step 40, the step 32 to the step 36).

Thus, with respect to the subject sort “sea”, when there are selected three discriminators associated with three characteristic amount sorts of B-value average, B-value (80%)−B-value (20%), and color difference Cb (70%), if the right answer rate exceeds the threshold (YES in the step 37), those three discriminators are decided as discriminators for discriminating the subject sort “sea”. The characteristic amount sorts and the discrimination point groups in the three discriminators are stored in the certainty factor computing memory 21, as shown in FIG. 11.

The above mentioned processing is carried out on the subject sorts (for example, six sorts of “the sea”, “high chroma saturation”, “evening scene”, “night scene”, “blue sky”, and “high-key”) excepting the subject sorts “person's face” and “out of detection object”, so that the certainty factor computing memory 21 (FIG. 11) is completed.

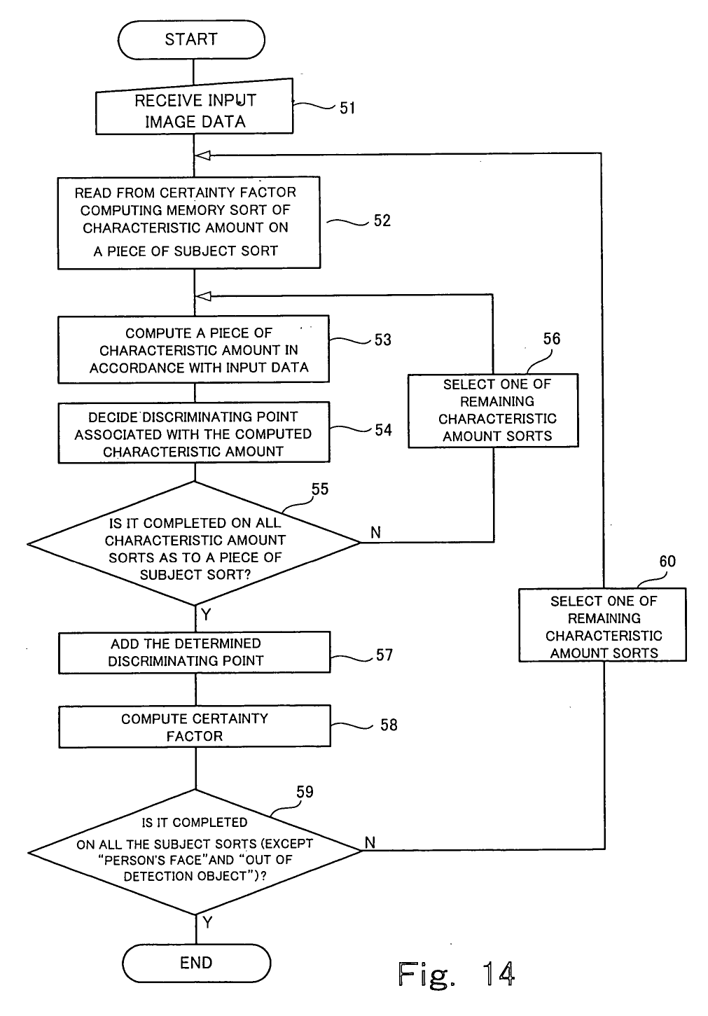

FIG. 14 is a flowchart useful for understanding processing for computing the certainty factor of the subject sorts (six sorts of “the sea”, “high chroma saturation”, “evening scene”, “night scene”, “blue sky”, and “high-key”) excepting the subject sorts “person's face” and “out of detection object”, on an input image, using the certainty factor computing memory 21.

The image analyzing section 12 performs the certainty factor computing processing on the subject sorts (“the sea”, “high chroma saturation”, “evening scene”, “night scene”, “blue sky”, and “high-key”) excepting the subject sorts “person's face” and “out of detection object”.

Input image data, which is read from a storage unit, is fed to the image analyzing section 12 (step 51).

The characteristic amount sort and the discrimination point group on one (for example, “the sea”) of the subject sorts are read from the certainty factor computing memory 21 and are stored in a temporary memory (not illustrated) (step 52).

The characteristic amount on a characteristic amount sort (either one of a plurality of characteristic amount sorts) stored in the temporary memory, is computed in accordance with the input image data. For example, in case of the subject sort “the sea”, the characteristic amount sorts for computing the certainty factor are three sorts of B-value average, B-value (80%)−B-value (20%), and color difference Cb (70%). One (for example, B-value average) of those three characteristic amount sorts is computed in accordance with the input image data (step 53).

The discriminating point associated with the computed characteristic amount is decided in the discriminating point group stored in the temporary memory (step 54).

With respect to all the characteristic amount sorts associated with one subject sort, it is judged whether the discriminating point is decided (step 55). In the event that the remaining characteristic amount sorts exist, one of the remaining characteristic amount sorts is selected. Regarding the selected characteristic amount sort, the characteristic amount is computed in a similar fashion to that of the above, so that the discriminating point associated with the computed characteristic amount is decided (“NO” in step 55, step 56, and steps 53 to 54).

When there is decided the discriminating point on all the characteristic amount sorts associated with one subject sort, the determined discriminating point is added (hereinafter, it is referred to as an added discriminating point) (“YES” in step 55, step 57).

The certainty factor is computed in accordance with the value of the added discriminating point and the number of the characteristic amount sorts associated with one subject sort (step 58).

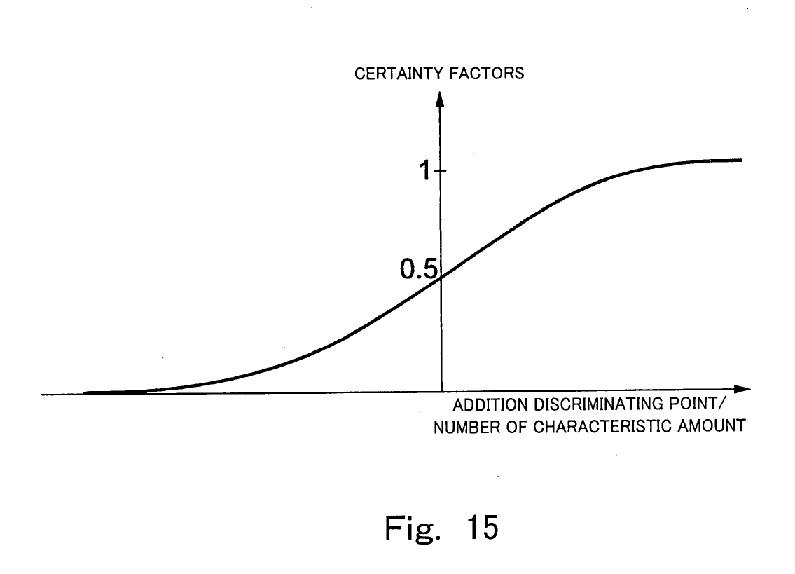

FIG. 15 is a graph showing an example of a function used for computation of the certainty factor.

Certainty factors (numerical values from 0 to 1) associated with a value, where the added discriminating point is divided by the number of the characteristic amount sorts, are computed in accordance with the function shown in FIG. 15. The computed certainty factors for one subject sort are stored in the temporary memory.

The above-mentioned processing is carried out on the subject sorts (for example, six sorts of “the sea”, “high chroma saturation”, “evening scene”, “night scene”, “blue sky”, and “high-key”) excepting the subject sorts “person's face” and “out of detection object” (“NO” in step 59, step 60). Finally, the certainty factors on the individual subject sorts of “the sea”, “high chroma saturation”, “evening scene”, “night scene”, “blue sky”, and “high-key” are stored in the temporary memory (“YES” in step 59) (function blocks 12b to 12g).

Next, there will be explained a certainty factor computation on the subject sort (person's face).

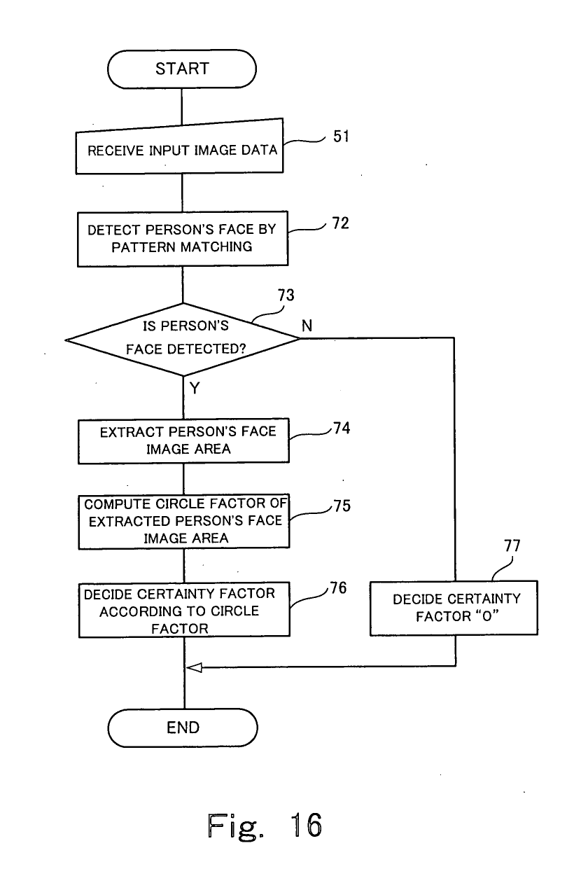

FIG. 16 is a flowchart useful for understanding processing for the certainty factor computation on the “person's face” of the subject sort.

The image analyzing section 12 performs the processing for the certainty factor computation on the “person's face” of the subject sort.

As the input image data, there is used one which is the same as that used in computation for certainty factors on the subject sorts “the sea”, “high chroma saturation”, “evening scene”, “night scene”, “blue sky”, and “high-key” (step 51).

The use of a pattern matching (for example, a pattern matching utilizing a shading pattern for a typical person's face) makes it possible to detect whether the image represented by input image data includes an image portion representative of a person's face (step 72). The person's face pattern data memory 22, which is connected to the image analyzing section 12, stores a plurality of pattern data mutually different in data capacity. The use of the plurality of pattern data makes it possible to detect whether the input image includes an image portion representative of a person's face.

When it is decided by the pattern matching that the input image does not include an image portion, it is determined that the certainty factor of the subject sort “person's face” is “0” (“NO” in step 73, step 77).

When it is decided by the pattern matching that the input image include an image portion (“YES” in step 73), there are obtained by the pattern matching an approximate center of a person's face (for example, relative coordinates) and an approximate magnitude (based on a magnitude of the pattern data used in the pattern matching). There is cut out, from the input image, a rectangular area including a person's face (a rectangular area having a high possibility that a person's face is included) in accordance with the thus obtained approximate center of the person's face and approximate magnitude. Extraction processing for the person's face image area is carried out in accordance with the cut out rectangular area image (step 74).

It is possible for the extraction processing for the person's face image area to adopt various types of processing.

For example, color data (RGB) of pixels having the same based color is converted into a predetermined value in accordance with image data representative of the rectangular area, so that there is created image data in which pixel having color data of skin color and color closed to the skin color, pixel having color data of white color and color closed to the white color, and pixel having color data of black color and color closed to the black color, are gathered. Thereafter, portions, wherein no edge exists, are integrated so that portions of the skin color and color closed to the skin color, of the integrated image portion, are established as the person's face image area.

In the rectangular area represented by image data representative of the rectangular area, there are determined edge positions (boundary positions between the skin color and colors other than skin color) on individual directions (for example, 64 directions) directed from the center to the periphery, so that an area, which is defined by coupling the determined 64 edge positions with one another, is established as a person's face image area.

When the image data representative of the person's face image area is extracted from image data representative of the rectangular area, a circle factor of the extracted person's face image area (step 75). The circle factor is computed in accordance with the following equation 4.
Circle factor=(peripheral length L×peripheral length L)/area S (Equation 4)

There is determined the certainty factor according to the circle factor computed in accordance with the equation 4 (step 76). In determination of the certainty factor according to the circle factor, it is acceptable to use the function (graph) shown in FIG. 15, or alternatively to use another function.

The certainty factor as to the determined subject sort “person's face” is also stored in the temporary memory (the function block 12a).

In the event that the input image includes a plurality of person's faces, there are computed certainty factors on individual pluralities of person's faces to compute the average. The computed average is regarded as the certainty factor on the subject sort “person's face”.

When the certainty factors on all the individual subject sorts (“person's face”, “the sea”, “high chroma saturation”, “evening scene”, “night scene”, “blue sky”, and “high-key”) excepting the subject sort “out of detection object” are computed, the computed certainty factors are used to compute a certainty factor on the subject sort “out of detection object”. A certainty factor Pot on the subject sort “out of detection object” is computed in accordance with the following equation 5 (the function block 12h).
Pot=1−MAX(P1,P2, . . . ,P7) (Equation 5)

Where P1, P2, . . . , P7 denote the certainty factors of the subject sorts excepting the subject sort “out of detection object”. MAX (P1, P2, . . . , P7) denote the maximum values of P1, P2, . . . , P7.

According to the above-mentioned processing, regarding the input image, there are computed the certainty factors (total eight certainty factors) on the individual subject sorts (“person's face”, “the sea”, “high chroma saturation”, “evening scene”, “night scene”, “blue sky”, “high-key”, and “out of detection object”).

Next, there will be explained the processing of the density obtaining section 13.

The density obtaining section 13 determines the density correcting values on the individual subject sorts (“person's face”, “the sea”, “high chroma saturation”, “evening scene”, “night scene”, “blue sky”, “high-key”, and “out of detection object”) in accordance with the input image data. In the above-mentioned certainty factor computing processing, it is acceptable that the density correcting value on the subject sort involved in “0” in certainty factor is not necessarily determined.

Next, there will be explained a computation of density correcting values on individual subject sorts “person's face”, “the sea”, “high chroma saturation”, “evening scene”, “night scene”, “blue sky”, “high-key”, and “out of detection object”.

(1) a computation of density correcting value on subject sort “person's face” (the function block 13a)

The image analyzing section 12 determines person's face image areas included in the input image and their associated certainty factors, and applies those to the density obtaining section 13. The density obtaining section 13 specifies pixels constituting the person's face in the input image in accordance with the applied person's face image areas and their associated certainty factors, and computes the average density weighted with the associated certainty factor. The thus computed weighted average density is used to compute a correcting factor that is a target density value of a person's face included in the “template 1”. There are created density correcting values (table or function defining output densities (0 to 4095) associated with input densities (0 to 4095)) in accordance with the computed correcting factor (in case of a 12 bits density scale).

(2) a computation of density correcting value on subject sort “the sea” (the function block 13b)

Of the pixels constituting the input image, there are detected pixels within a color range of a blue color to a green color so as to determine density that is minimum in visual density. There is computed a correcting factor in which the minimum visual density is the target density value of “the sea” included in the “template 1”, and then the density correcting value is computed in accordance with the computed correcting factor. What is meant by the visual density is density in which C-density, M-density, and Y-density are weighted with 3:6:1. This density is proportional to the luminous intensity.

(3) a computation of density correcting value on subject sort “high chroma saturation” (the function block 13c)

Of the pixels constituting the input image, there are detected pixels having a color phase that is highest in chroma saturation so as to determine density that is minimum in visual density. There is computed a correcting factor in which the minimum visual density is the target density value of “high chroma saturation” included in the “template 1”, and then the density correcting value is computed in accordance with the computed correcting factor.

(4) a computation of density correcting value on subject sort “evening scene” (the function block 13d)

In the event that the input image is the evening scene image, there exist in the input image pixels having colors belonging to the color range of the orange color. There are detected pixels having colors belonging to the color range of the orange color so as to determine density that is minimum in visual density. There is computed a correcting factor in which the minimum visual density is the target density value of “evening scene” included in the “template 1”, and then the density correcting value is computed in accordance with the computed correcting factor.

(5) a computation of density correcting value on subject sort “night scene” (the function block 13e)

In the event that the input image is the night scene image, there exist in the input image pixels (a highlight portion) that are low in density, and pixels (a shadow portion) that are high in density. There is computed a correcting factor in which the minimum density is the target density value of the highlight included in the “template 1”, and the maximum density is the target density value of the shadow included in the “template 1”.

(6) a computation of density correcting value on subject sort “blue sky” (the function block 13f)

In the event that the input image is the blue sky image, there exist in the input image pixels having colors belonging to the color range of the cyan blue color. There are detected pixels having colors belonging to the color range of the cyan blue color so as to determine density that is minimum in visual density. There is computed a correcting factor in which the minimum visual density is the target density value of “blue sky” included in the “template 1”, and then the density correcting value is computed in accordance with the computed correcting factor.

(7) a computation of density correcting value on subject sort “blue sky” (the function block 13g)

In the event that the input image is the high-key image, there exist in the input image pixels having colors belonging to the color range of the white color. There are detected pixels having colors belonging to the color range of the white color so as to determine density that is minimum in the minimum density of C, M and Y. There is computed a correcting factor in which the minimum density is the target density value of “high-key” included in the “template 1”, and then the density correcting value is computed in accordance with the computed correcting factor.

(8) a computation of density correcting value on subject sort “out of detection object” (the function block 13h)

There are computed visual densities of all the pixels constituting the input image. There is computed a correcting factor in which the average value is the target density value of the average value included in the “template 1”, and then the density correcting value is computed in accordance with the computed correcting factor.

A method of computing the density correcting value on the individual subject sorts is not restricted to the above-mentioned schemes. For example, as to the subject sort “person's face”, it is acceptable to adopt such a scheme that in addition to the average density of pixels constituting the “person's face”, the minimum density and the maximum density are computed or detected, and there are computed correcting functions in which the average density, the minimum density and the maximum density offer the associated target densities (the target average density, the target minimum density and the target maximum density), so that the computed correcting functions are regarded as the density correcting values. In the event that the density correcting values are expressed by a graph, it is acceptable that the graph is shaped as a straight line or a curve.

The density correcting value integration section 14 receives density correcting values Ti(s) on the individual pluralities of subject sorts computed by the density obtaining section 13, certainty factors Pi on the individual pluralities of subject sorts computed by the image analyzing section 12, and importance factors Si on the individual pluralities of subject sorts entered using an input device. The density correcting value integration section 14 computes the integrated density correcting value T(s) in accordance with the equations 1 and 2 (function block 14a).

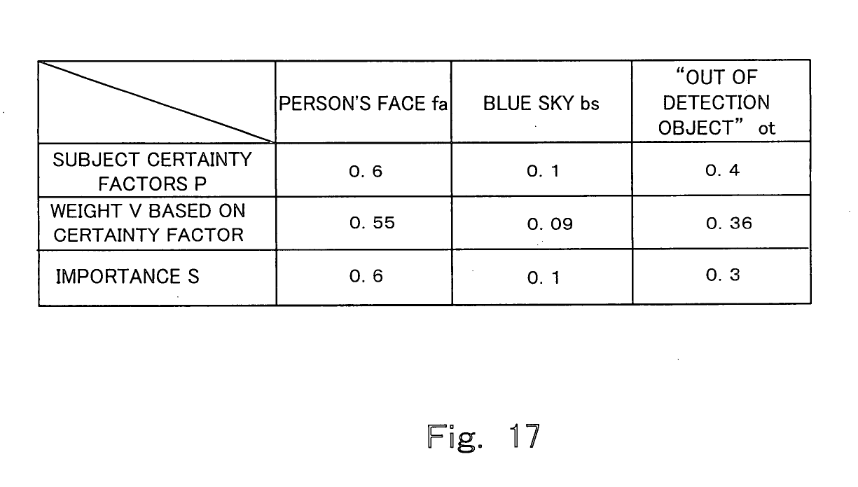

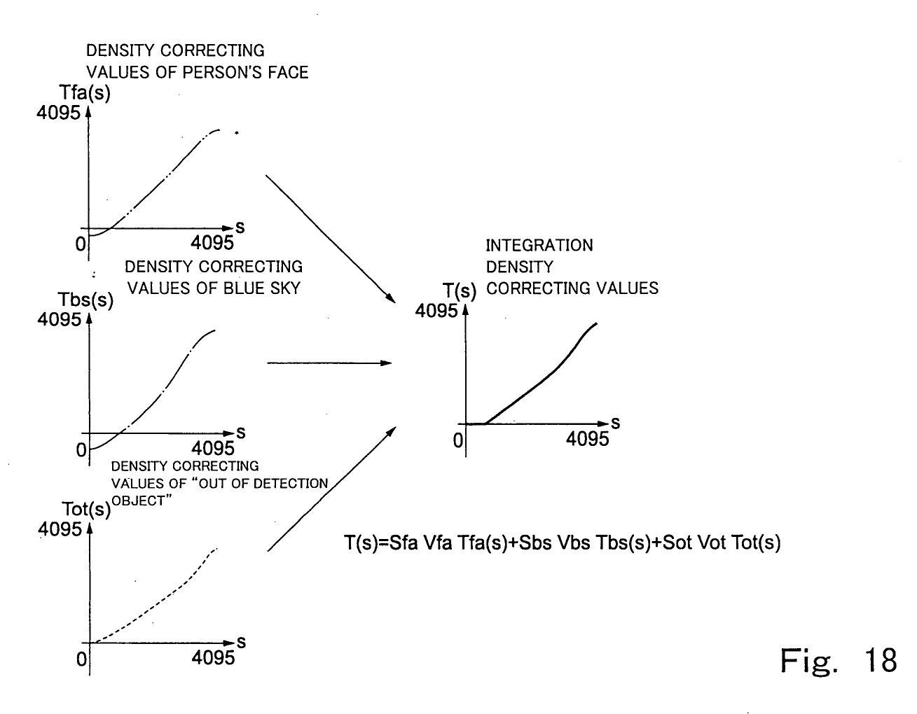

Hereinafter, there will be explained creation of the integrated density correcting value of the density correcting value integration section 14 referring to FIG. 17 and FIG. 18.

FIG. 17 is an explanatory view useful for understanding creation of the integration density correcting value in the density correcting value integration section 14. FIG. 18 is an explanatory view useful for understanding creation of the integration density correcting value in the density correcting value integration section 14.

For example, in the event that the certainty factor obtained from the input image is 0.6 on the subject sort “person's face”, 0.1 on the subject sort “blue sky”, and 0 on other subject sorts, the certainty factor on the sort “out of detection object” is 0.4 in accordance with the equation 5 (FIG. 17). In accordance with the equation 2, there are computed weight Vfa(=0.55) of the subject sort “person's face”, weight Vbs(=0.09) of the subject sort “blue sky”, and weight Vot(=0.36) of the subject sort “out of detection object”. An operator of the image processing system enters the importance factors Sfa of the subject sort “person's face”, Sbs of the subject sort “blue sky”, and Sot of the subject sort “out of detection object”. Where the importance factor Sfa of the subject sort “person's face” is 0.6, the importance factor Sbs of the subject sort “blue sky” is 0.1, and the importance factor Sot of the subject sort “out of detection object” is 0.3.

There are multiplied together: weight Vfa of the subject sort “person's face”, weight Vbs of the subject sort “blue sky”, and weight Vot of the subject sort “out of detection object”; the importance factors Sfa of the subject sort “person's face”, Sbs of the subject sort “blue sky”, and Sot of the subject sort “out of detection object”; and the density correcting values (Tfa(s), Tba(s), and Tot(s)) of the subject sort “person's face”, the subject sort “blue sky”, and the subject sort “out of detection object” (at the left side of FIG. 18, there are shown Tfa(s), Tba(s), and Tot(s) with the graphs) in accordance with the equation 1. The addition result is regarded as the integration density correcting value (Ts) (at the right side of FIG. 18, there is shown the integration density correcting value (Ts) with the graph). In the graphs of the density correcting values Tfa(s) and Tba(s) of the subject sort “person's face” and the subject sort “blue sky” shown at the left side of FIG. 18, there are found portions in which the output density values (Tfa(s) and Tba(s)) associated with the input density value (s) take the negative values (levels). The reason why this is to do so is that the target value is set up so that the density correcting values are computed in a direction that an image is light. In the finally obtained integration density correcting value (Ts), the portions, wherein the output density values take the negative values, are clipped so that the output density values offer anyone of 0 to 4095 in the density level (cf. the graph of the integration density correcting value (Ts) appearing at the right side of FIG. 18.

The thus created integration density correcting value (Ts) is used to correct the input image data in the image processing section 15.

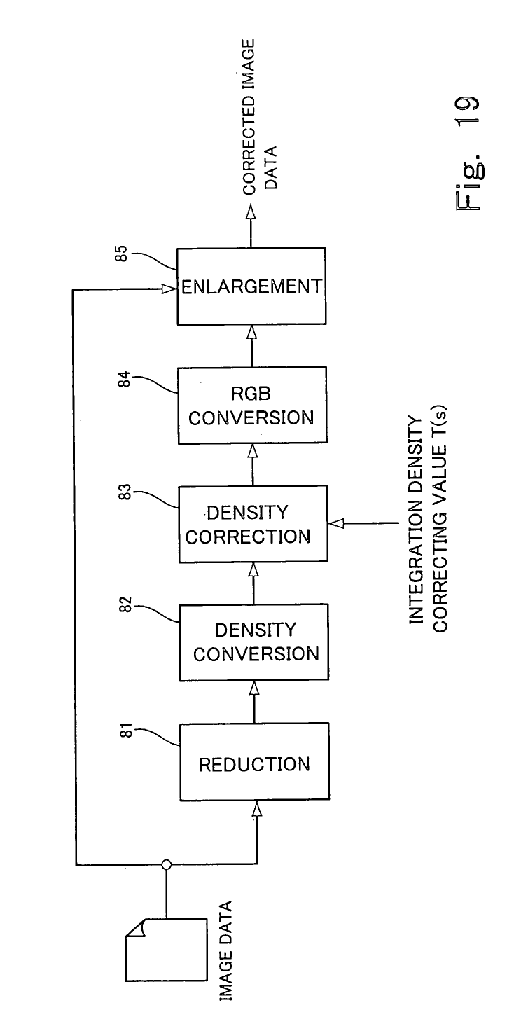

FIG. 19 is a functional block diagram of the image processing section 15.

The image processing section 15 receives input image data that is the same as that fed to the image analyzing section 12 and the density obtaining section 13.

There is performed a reduction processing (function block 81). According to the reduction processing, the number of pixels of an image involved in the large number of pixels is reduced so as to reduce the processing time of the subsequent density conversion processing, density correcting processing and RGB conversion processing. The reduction processing is carried out in the event that the image data after the density correction is reduced and outputted. In the event that the image data after the density correction is enlarged and outputted, the reduction processing is not carried out.

There are computed densities on the individual pixels constituting the reduced input image (function block 82).

The above-mentioned integration density correcting value (Ts) is used to correct densities of the individual pixels of the image that is subjected to the reduction processing (function block 83).

The image data is converted into RGB values for individual pixels of the input image in accordance with the corrected densities (function block 84). Finally, the enlargement processing is carried out (function block 85). The enlargement processing is carried out in the event that the image, which is subjected to the density correction, is enlarged and outputted. The enlargement processing is not carried out in the event that the image, which is subjected to the density correction, is reduced and outputted.

The image data subjected to the density correction, which is outputted from the image processing section 15, is stored in the output folder described in the job ticket.

When operators of the client machines 200, 210, and 220 requires the print output of the image data stored in the output folder, the image processing apparatus 100_1′ transmits the image data to the RIP servers 300 and 310, and further transmits the image data to printers 610 and 620 so as to print out an image represented by the image data.

In the manner as mentioned above, the image processing apparatus 100_1′ automatically discriminate or detect the subject sorts included in the image represented by input image data, and performs auto set up processing using the density correcting values which are adjusted by the operators beforehand. Hence, even if the operators have no special knowledge of the image processing, the operators perform the image processing for reflecting one wishes, and thereby obtaining an image that is nice to look at.

According to the above-mentioned explanation, as an example of the processing parameter referred to in the present invention, there is raised an example in which density values of an image are applied. It is acceptable, however, that the processing parameter referred to in the present invention is others than the density values. Hereinafter, there will be described examples of the processing parameters.

<Degree of Contrast>

When the contrast factor becomes large (the contrast direction), it is possible to correct the image into a contrasty image. When the contrast factor becomes small (the soft direction), it is possible to correct the image to a soft image.

<Highlight (HL) Tone Save>

In the event that a tone of the HL side of an image after the auto set up collapses, when the HL tone saving factor becomes large (HL priority direction), it is possible to correct the image into an image in which the tone of the HL side is saved. Reversely, when the HL tone saving factor becomes small (SD priority direction), it is possible to correct the image into an image in which the middle to the tone of the SD is saved.

<Color Balance Correcting Target Color>

Only in case of the person's face image and the high-key image, factors of redness and blueness are adjusted to control redness and blueness.

<Front Face Retrieval Size>

A reference size of retrieving a person's face is adjusted. When the reference size becomes small, it is possible to apply image processing with great accuracy, even if a small one's face appears in the group photography. Reversely, when the reference size becomes large, it is possible to improve a processing speed. In this case, image processing is applied to only a face of portrait or so.

As mentioned above, according to the present invention, it is possible to provide an image processing apparatus capable of readily correcting an image represented by image data to an image having a color shade that is nice to look at, which reflects an operator's taste, an image processing system, and an image processing program storage medium storing an image processing program, when executed in a computer, which causes the computer to operate as the image processing apparatus.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. An image processing apparatus comprising:
an image data obtaining section that obtains image data;
an image analyzing section that analyzes an image represented by the image data obtained by the image data obtaining section;
an image processing section that applies image processing to the image data obtained by the image data obtaining section in accordance with an analyzing result analyzed by the image analyzing section and a processing parameter for introducing processing contents from the analyzing result; and
a parameter adjusting section that adjusts, prior to the image processing by the image processing section, the processing parameter in accordance with an operation.

2. An image processing apparatus according to claim 1, wherein the image processing apparatus further comprises a saving section that saves the processing parameter adjusted by the parameter adjusting section, and
the image processing section applies the image processing according to the processing parameter save in the saving section.

3. An image processing apparatus according to claim 1, wherein the image analyzing section analyzes a scene of the image represented by the image data to classify a predetermined plurality of scene types,
the image processing section applies the image processing to the image data obtained by the image data obtaining section in accordance with the processing parameter associated with the scene type classified by the image analyzing section,
the processing parameter is a plurality of parameters associated with the plurality of scene types, and
the parameter adjusting section individually adjusts the processing parameters.

4. An image processing system comprising:
an image data obtaining section that obtains image data;
an image analyzing section that analyzes an image represented by the image data obtained by the image data obtaining section;
an image processing section that applies image processing to the image data obtained by the image data obtaining section in accordance with an analyzing result analyzed by the image analyzing section and a processing parameter for introducing processing contents from the analyzing result; and
a parameter adjusting section that adjusts, prior to the image processing by the image processing section, the processing parameter in accordance with an operation.

5. An image processing program storage medium storing an image processing program which causes a computer to operate as an image processing apparatus, when the image processing program is executed in the computer, the image processing apparatus comprising:
an image data obtaining section that obtains image data;
an image analyzing section that analyzes an image represented by the image data obtained by the image data obtaining section;
an image processing section that applies image processing to the image data obtained by the image data obtaining section in accordance with an analyzing result analyzed by the image analyzing section and a processing parameter for introducing processing contents from the analyzing result; and
a parameter adjusting section that adjusts, prior to the image processing by the image processing section, the processing parameter in accordance with an operation.
